(19) United States
(12) Patent Application Publication
(10) Pub. No.: US 2013/0065208 A1
(43) Pub. Date: Mar. 14, 2013

(54) METHODS AND APPARATUS FOR EVALUATING A CANDIDATE'S PSYCHOLOGICAL FIT FOR A ROLE

(71) Applicants: Sean Peter Glass, Key West, FL (US); Mark Isaac Hammond, Berkley, CA (US); Adam Christopher Falla, London (GB); Keen McEwan Browne, Seattle, WA (US); Adoree Fausta Durayappah, Houston, TX (US)

(72) Inventors: Sean Peter Glass, Key West, FL (US); Mark Isaac Hammond, Berkley, CA (US); Adam Christopher Falla, London (GB); Keen McEwan Browne, Seattle, WA (US); Adoree Fausta Durayappah, Houston, TX (US)

(73) Assignee: Employ Insight, LLC, Key West, FL (US)

(21) Appl. No.: 13/229,035

(22) Filed: Sep. 9, 2011

(51) Int. Cl. G09B 19/00

(52) U.S. Cl. 434/236

(57) ABSTRACT

In some embodiments, a non-transitory processor-readable medium stores code representing instructions to cause a processor to receive a first psychological profile identifying one or more psychological facets associated with a candidate for a role and a set of second psychological profiles identifying one or more psychological facets associated with the role. Each second psychological profile is associated with an assessment of the role by an evaluator from a set of evaluators. The code represents instructions to cause the processor to receive a set of post-interview assessments, each of which is from an interviewer from a set of interviewers and includes a degree of confidence that the candidate possesses the one or more psychological facets associated with the candidate. The code further represents instructions to cause the processor to compute an indicator associated with the first psychological profile, the set of second psychological profiles and the set of post-interview assessments.

### BACKGROUND

Embodiments described herein relate generally to software tools to identify a psychological profile of a role, and more particularly, to methods and apparatus for evaluating a candidate's psychological fit for a particular role.

Some known software tools assist a hiring process by identifying a good match of skills and experience between a candidate and a role. These software tools, however, do not evaluate the psychological fit of a candidate for a role. To help enable happy, satisfied, and fulfilled employees, and to reap the commensurate rewards, employers should also look for a fit between a psychological profile of a candidate and the psychological facets a candidate will use in a role.

Some other known software tools use psychological instruments or methodologies to look at a candidate's personality and temperament assessment, and try to forecast his/her future within a role. These software tools, however, do not use any psychological assessment of the role in predicting overall effectiveness and satisfaction of a candidate for that role.

Accordingly, a need exists for methods and apparatus that help companies evaluate a candidate's psychological fit for a role by understanding the psychological capital used by the role and brought by the candidate, which potentially leads to increased retention and employee effectiveness for the companies.

### SUMMARY

In some embodiments, a non-transitory processor-readable medium stores code representing instructions to cause a processor to receive a first psychological profile identifying one or more psychological facets associated with a candidate for a role and a set of second psychological profiles identifying one or more psychological facets associated with the role. Each second psychological profile is associated with an assessment of the role by an evaluator from a set of evaluators. The code represents instructions to cause the processor to receive a set of post-interview assessments, each of which is from an interviewer from a set of interviewers and includes a degree of confidence that the candidate possesses the one or more psychological facets associated with the candidate. The code further represents instructions to cause the processor to compute an indicator associated with the first psychological profile, the set of second psychological profiles and the set of post-interview assessments.

### BRIEF DESCRIPTION OF THE DRAWINGS

FIG. 1 is a schematic diagram that illustrates communication devices in communication with a host device via a network, according to an embodiment.

FIG. 2 is a schematic illustration of a processor configured to evaluate a candidate's psychological fit for a role, according to an embodiment.

FIG. 3 is a flowchart illustrating a method for evaluating a candidate's psychological fit for a role, according to an embodiment.

FIG. 4 is an illustration of a role assessment interface, according to an embodiment.

FIG. 5 is an illustration of a position profile review interface, according to an embodiment.

FIG. 6 is an illustration of a profile match ranking interface, according to an embodiment.

FIG. 7 is an illustration of a post-interview analysis interface, according to an embodiment.

FIG. 8 is a flowchart illustrating a method for computing an indicator associated with a candidate's psychological fit for a role, according to an embodiment.

### DETAILED DESCRIPTION

In some embodiments, a non-transitory processor-readable medium stores code representing instructions to cause a processor to receive a first psychological profile identifying one or more psychological facets associated with a candidate for a role, and a set of second psychological profiles identifying one or more psychological facets associated with the role. Each second psychological profile from the set of second psychological profiles is associated with an assessment of the role by an evaluator from a set of evaluators. In some embodiments, the first psychological profile is based on a normative Likert survey associated with the candidate, and each second psychological profile is normalized from the set of second psychological profiles associated with the role based on a history of responses associated with the evaluator from the set of evaluators associated with that second psychological profile. The code also represents instructions to cause the processor to receive a set of post-interview assessments, each of which is from an interviewer from a set of interviewers and includes a degree of confidence that the candidate possesses the one or more psychological facets associated with the candidate.

The code further represents instructions to cause the processor to compute an indicator associated with the first psychological profile, the set of second psychological profiles and the set of post-interview assessments. The indicator indicates a degree of match between the candidate and the role. In some embodiments, the indicator can be computed using a Bhattacharyya distance. In some embodiments, the code represents instructions to cause the processor to compute a first probability distribution based on the set of second psychological profiles, and compute a second probability distribution based on the first psychological profile and the set of post-interview assessments. The code represents instructions to cause the processor to compute the indicator based on the first probability distribution and the second probability distribution.

Additionally, the code represents instructions to cause the processor to provide an assessment interface to each evaluator from the set of evaluators. The assessment interface is configured to present a set of assessment items (e.g., questions) to each evaluator along with a set of possible responses to each assessment item from the set of assessment items. At a first time, a first assessment item from the set of assessment items is a current item, and the set of possible responses is presented adjacent to the first assessment item. At a second time, a second assessment item from the set of assessment items is the current item, and the set of possible responses is presented adjacent to the second assessment item.

In some embodiments, an apparatus includes a candidate profile module, a position profile module, an analysis module and a question compilation module. In such embodiments, the candidate profile module can be configured to generate a psychological profile associated with a candidate for a role based on an assessment of the candidate. The candidate profile module can also be configured to identify one or more psychological facets of the candidate based on the psychological profile associated with the candidate. In some embodiments, the psychological profile associated with the candidate for the role is based on a normative Likert survey associated with the candidate.

In some embodiments, the position profile module can be configured to receive a set of psychological profiles associated with the role, each of which is associated with an assessment of the role by an evaluator from a set of evaluators. In some embodiments, the position profile module can be configured to identify one or more psychological facets associated with the role based on the set of psychological profiles. In some embodiments, the position profile module can be configured to modify an order of importance of the one or more psychological facets associated with the role based on a user input. In some embodiments, the position profile module can be configured to calculate an importance score for each psychological facet from the one or more psychological facets based on the set of psychological profiles associated with the role.

In some embodiments, the analysis module is configured to compute an indicator associated with a comparison of the one or more psychological facets of the candidate and the one or more psychological facets associated with the role. The indicator can be configured to assist in the selection of the candidate for an interview. In some embodiments, the analysis module is configured to compute the indicator using a Mahalanobis distance associated with the one or more psychological facets of the candidate and the one or more psychological facets associated with the role.

In some embodiments, the question compilation module can be configured to select a set of interview questions from a set of interview questions that elicit information usable to assess whether the candidate possesses the one or more psychological facets associated with the role. In some embodiments, the apparatus further includes a post-interview assessment module. The post-interview assessment module is configured to select a set of post-interview items (e.g., questions) from a set of post-interview items that elicit information usable to assess an interviewer's degree of confidence that the candidate possesses the one or more psychological facets of the candidate.

As used herein a “role” and/or a “position” can include a job category and/or a specific or particular position or role. For example, a role can include a job category such as a front-end web engineer, a legal administrative assistant, and/or the like. Similarly, for example, a role can include a specific or particular position or role such as a particular job posting and/or job opening a company is attempting to fill. Such a particular position or role can be, for example, a front-end web engineer in a specific department at a specific company, a legal administrative assistant for a specific attorney or law firm, and/or the like. A particular position can also include staffing a specific project within a particular company, a specific promotion within a particular company, and/or the like.

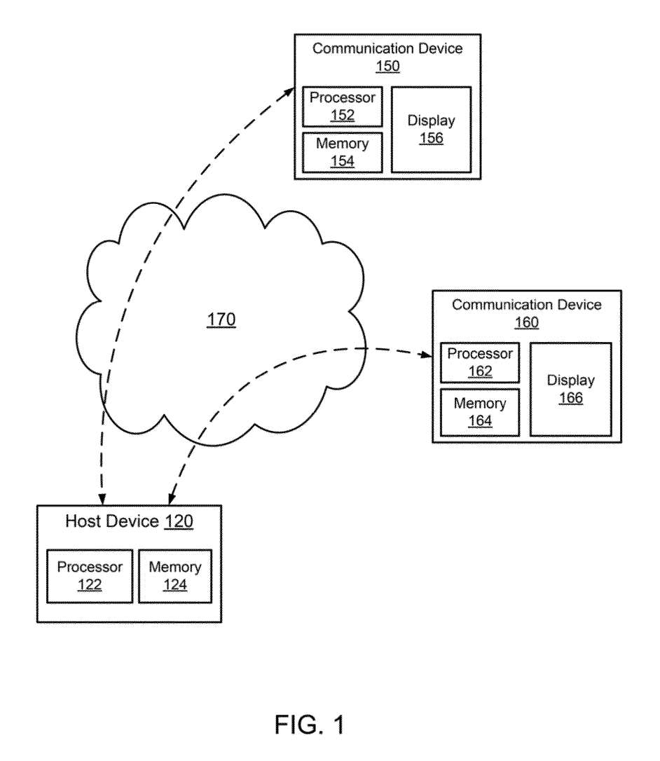

FIG. 1 is a schematic diagram that illustrates communication devices in communication with a host device via a network, according to an embodiment. Specifically, the communication devices 150 and 160 are configured to communicate with the host device 120 via the network 170. The network 170 can be any type of network (e.g., a local area network (LAN), a wide area network (WAN), a virtual network, a telecommunications network, etc.) implemented as a wired network and/or wireless network. In some embodiments, for example, the communication devices 150 and 160 can be personal computers connected to the host device 120 via an Internet service provider (ISP) and the Internet (e.g., network 170). Although only the communication devices 150 and 160 are shown in FIG. 1, the host device 120 can be configured to be operatively coupled to and communicate with more than two communication devices via the network 170.

The host device 120 can be any type of device configured to send data over the network 170 to and/or receive data from one or more of the communication devices (e.g., the communication device 150, 160). In some embodiments, the host device 120 can be configured to function as, for example, a server device (e.g., a web server device), a network management device, and/or so forth.

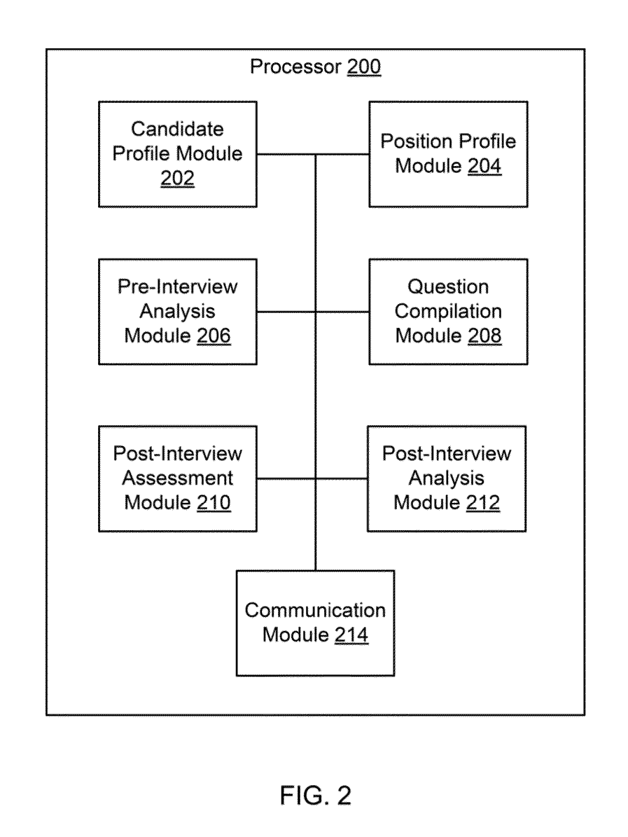

As shown in FIG. 1, the host device 120 includes a memory 124 and a processor 122. The processor 122 can be similar to processor 200 shown and described in detail with respect to FIG. 2. Specifically, the processor 122 can include multiple hardware-based and/or software-based modules (stored and/or executing in hardware), each of which can perform a specific function associated with an evaluation process that evaluates a candidate's psychological fit for a role. Such an evaluation can be used, for example, to fill a job opening, to staff a project, to determine a promotion, to analyze the psychological profile of an individual or group, to analyze the strengths and/or weaknesses of a group, and/or the like. The memory 124 can be, for example, a random access memory (RAM), a memory buffer, a hard drive, a database, and/or so forth. In some embodiments, the memory 124 of the host device 120 includes data used to facilitate an evaluation process. In such embodiments, for example, the host device 120 can send data to and receive data from the communication device 150 or 160 associated with the evaluation process. For example, as described in further detail herein, the host device 120 can send data associated with a role assessment or a candidate assessment (e.g., data associated with presenting a role assessment interface or a candidate assessment interface that includes a questionnaire) to the communication device 150 or 160. For another example, the host device 120 can receive data associated with responses to a role assessment or a candidate assessment (e.g., answers to the questionnaire from a role evaluator or a candidate) from the communication device 150 or 160.

In some embodiments, the memory 124 of the host device 120 can act as a data repository. In such embodiments, the data associated with the evaluation process (e.g., a candidate profile, a position profile, interview questions, etc.) can be stored in the memory 124 of the host device 120. When a user (e.g., a supervisor, a hiring manager, etc.) wishes to view data associated with a specific candidate and/or a role via, for example, the communication device 150 or 160, the host device 120 can send the data to the communication device 150 or 160 when a signal requesting the data is received from the communication device 150 or 160.

Further, in some embodiments, the memory 124 of the host device 120 can store account information associated with users authorized to access the data stored in the memory 124. Each user can be authorized to access certain locations of the data stored in the memory 124. In some embodiments, for example, a supervisor can be authorized to access both candidate profiles and position profiles; while an employee can be authorized to access position profiles only. In such embodiments, for example, the host device 120 can store, within the memory 124, a username and password associated with a user, extent of authority of the user (e.g., access rights), a list of tasks for the user to complete, and/or the like. Alternatively, such information can be stored in a database (not shown in FIG. 1) within or operatively coupled to the host device 120.

The communication device 150 or 160 can be, for example, a computing entity (e.g., a personal computing device such as a desktop computer, a laptop computer, etc.), a mobile phone, a monitoring device, a personal digital assistant (PDA), and/or so forth. Although not shown in FIG. 1, in some embodiments, the communication device 150 or 160 can include one or more network interface devices (e.g., a network interface card) configured to connect the communication device 150 or 160 to the network 170. In some embodiments, the communication devices 150 and 160 can be referred to as client devices.

As shown in FIG. 1, the communication device 160 has a processor 162, a memory 164, and a display 166. The memory 164 can be, for example, a random access memory (RAM), a memory buffer, a hard drive, and/or so forth. The display 166 can be any suitable display, such as, for example, a liquid crystal display (LCD), a cathode ray tube display (CRT) or the like. The processor 162 can be similar to the processor 122 in the host device 120. Particularly, the processor 162 can include one or more hardware-based and/or software-based modules (stored and/or executing in hardware) that are configured to perform one or more specific functions associated with an evaluation process, similar to the modules included in the processor 122. Similar to communication device 160, the communication device 150 has a processor 152, a memory 154, and a display 156.

In some embodiments, a web browser application can be stored in the memory 164 of the communication device 160. Using the web browser application, the communication device 160 can send data to and receive data from the host device 120. Similarly, the communication device 150 can include a web browser application. In such embodiments, the communication devices 150 and 160 can act as thin clients. This allows minimal data to be stored on the communication devices 150 and 160. In other embodiments, the communication devices 150 and 160 can include one or more applications specific to communicating with the host device 120 during an evaluation process. In such embodiments, the communication devices 150 and 160 can download the application(s) from the host device 120 prior to participating in the evaluation process.

As discussed above, the communication devices 150 and 160 can send data to and receive data from the host device 120 associated with an evaluation process. In some embodiments, the data sent between the communication devices 150, 160 and the host device 120 can be formatted using any suitable format. In some embodiments, for example, the data can be formatted using extensible markup language (XML), hypertext markup language (HTML) and/or the like.

In some embodiments, one or more portions (e.g., the processor 122) of the host device 120 and/or one or more portions (e.g., the processor 152, 162) of the communication device 150 or 160 can include a hardware-based module (e.g., a digital signal processor (DSP), a field programmable gate array (FPGA)) and/or a software-based module (e.g., a module of computer code to be executed at a processor, a set of processor-readable instructions that can be executed at a processor). In some embodiments, one or more of the functions associated with the host device 120 (e.g., the functions associated with the processor 122) can be included in one or more such modules (see, e.g., FIG. 2). In some embodiments, one or more of the functions associated with the communication device 150 or 160 (e.g., functions associated with processor 152 or processor 162) can be included in one or more modules similar to the modules shown and described with respect to FIG. 2. In some embodiments, one or more of the communication devices such as the communication devices 150 and 160 can be configured to perform one or more functions associated with the host device 120, and vice versa.

Although shown in FIG. 1 and described herein as the host device 120 configured to be in communication with the communication device 150 or 160 to complete an evaluation process, in other embodiments, an evaluation process can be completed solely at a single device, such as the host device 120. In such embodiments, the personnel involved in the evaluation process, including a manager, candidates, evaluators, interviewers, etc., can access and operate on the host device 120, which hosts the necessary hardware and software modules including the functions associated with the evaluation process. In such embodiments, the host device 120 need not be coupled to any network (e.g., the network 170) or communication device (e.g., the communication devices 150, 160). In such embodiments, for example, the host device 120 can be a personal computer (PC) with software (executing in a processor) to execute the evaluation process.

FIG. 2 is a schematic diagram of a processor 200 configured to evaluate a candidate's psychological fit for a role, according to an embodiment. As shown in FIG. 2, processor 200 includes candidate profile module 202, position profile module 204, pre interview analysis module 206, question compilation module 208, post-interview assessment module 210, post-interview analysis module 212 and communication module 214. Each of the modules can be a hardware-based module (e.g., a DSP, a FPGA), a software-based module (e.g., a module of computer code to be executed at processor 200, a set of processor-readable instructions that can be executed at processor 200), or a combination of hardware and software modules. Each module hosted in processor 200 can be operatively coupled to each other module hosted in processor 200. Processor 200 can be hosted at a host device, similar to the host device 120 that includes the processor 122 as shown in FIG. 1.

Although each module is shown in FIG. 2 as being included in processor 200, in some other embodiments, some of the modules shown in FIG. 2 can be hosted at a processor in a communication device operatively coupled to the host device. For example, candidate profile module 202 and position profile module 204 can be hosted at the processor 152 in the communication device 150 shown in FIG. 1. While each module is shown in FIG. 2 as being in direct communication with every other module, in other embodiments, each module need not be in direct communication with every other module. For example, candidate profile module 202 might not be in direct communication with post-interview analysis module 212.

Candidate profile module 202 can be configured to provide a candidate assessment to each candidate associated with a role (e.g., a job opening, a promotion, a current position, a particular role, a job category, etc.). In some embodiments, the candidate assessment provided to a candidate can include items (e.g., questions) configured to elicit information associated with one or more facets that together define a psychological profile of the candidate. Each facet can be selected as a character facet that can identify a candidate's psychological strengths and/or weaknesses. Thus, the facets can be used to evaluate a candidate's psychological fit for the role. In some embodiments, for example, a set of 24 facets that can be used include: appreciation of beauty and excellence; bravery; citizenship (loyalty); creativity; curiosity; fairness; forgiveness and mercy; gratitude; hope; humor; integrity; judgment; kindness; leadership; love; love of learning; modesty and humility; persistence; perspective; prudence; self-regulation; social intelligence; spirituality; and zest.

In some embodiments, candidates can be solicited to complete a candidate assessment as part of their application for being evaluated for a role. For example, candidates can be provided, from an email or an advertisement on the Internet, a specific web address to complete the candidate assessment. The data entered by a candidate for the candidate assessment is then tracked and reported to candidate profile module 202.

In some embodiments, candidate profile module 202 hosted at a host device can be configured to present the candidate assessment, on a display of a communication device operatively coupled to the host device, to a candidate that accesses the communication device. For example, as shown in FIG. 1, candidate profile module 202 hosted at the processor 122 of the host device 120 can present a candidate assessment, on the display 156 of the communication device 150, to a candidate that accesses the communication device 150.

Subsequently, based on the answers provided by the candidate in response to the candidate assessment, a psychological profile identifying facets (e.g., psychological strengths, psychological weaknesses, etc.) associated with the candidate can be generated at the communication device and then sent to the host device. As a result, candidate profile module 202 is configured to receive the psychological profile. In some embodiments, such a psychological profile that identifies facets associated with a candidate is referred to as a candidate profile. Thus, candidate profile module 202 is configured to receive a candidate profile from each candidate, and then store the received candidate profiles.

The candidate assessment can be any suitable psychological assessment that can identify a candidate's profile of character facets. For example, the candidate assessment can be the Values in Action Inventory of Strengths (VIA-IS) or the like. In some embodiments, such a candidate assessment is specialized based on a particular role for which the candidate is being evaluated. In some other embodiments, such a candidate assessment is not dependent on any particular role. Similarly stated, in such embodiments the candidate assessment is a standard psychological assessment applicable to multiple roles and/or a job category.

In some embodiments, the form of the candidate assessment can be a survey using, for example, a seven point Likert scale and consisting of a combination of positively keyed, negatively keyed, and omitted queries. In such embodiments, a score on each facet can be computed for a candidate based on the candidate's answers to the queries associated with that facet. Furthermore, in some embodiments, the score on a facet can be normalized based on a probability distribution of answers to the queries associated with the facets. As a result, a candidate can determine her or his top facets (e.g., psychological strengths) based on the normalized scores of the facets (represented by uᵢ for facet i) from the candidate profile for that candidate.

Position profile module 204 can be configured to provide a psychological assessment that allows an evaluator to assess the importance of one or more facets for a role. In some embodiments, an evaluator can be selected from employees familiar with the role, such as employees current or previously in that role, employees that have collaborated with others in the role, employees that have managed or will manage individuals in the role, and/or the like. Similar to the candidate assessment that determines the relative role that each of the facets play in the lives of the candidates, the psychological assessment provided by position profile module 204 determines the relative role or importance of each facet for the role. In some embodiments, such a psychological assessment can be referred to as a role assessment.

In the example of a hiring process, when a new job opening (e.g., junior associate) is initially generated, a position profile can be initially defined for that position and/or role by, for example, a hiring manager, using position profile module 204. If the new opening is similar to one or more previous positions, the hiring manager creating the opening can elect to include the position profiles (i.e., role assessments) for those positions as a starting point to generate an initial position profile for the current position. For example, to “copy” existing position profiles when the new position has the same or similar requirements as the previous positions.

Once a position has been opened and a position profile has been initially defined for that position, the hiring manager can invite a group of evaluators to help complete a role assessment for that position and/or job category. This process allows for obtaining multiple perspectives about what psychological facets are typically used or desired in the position and/or job category. Specifically, each selected evaluator can complete a role assessment for the position and/or job category. This role assessment is used to establish the position profile against which candidates for the position will be compared to ascertain psychological fit.

Similar to the candidate assessment described above, position profile module 204 hosted at a host device can be configured to present the role assessment in the form of, for example, a role assessment interface, on a display of a communication device remotely coupled to the host device. Thus, an evaluator can access the communication device to complete the role assessment. The completed role assessment is then sent from the communication device to position profile module 204 of the host device. For example, as shown in FIG. 1, position profile module 204 hosted at the processor 122 of the host device 120 can present a role assessment, on the display 156 of the communication device 150, to an evaluator that accesses the communication device 150. The evaluator can complete the role assessment using the communication device 150. The completed role assessment can then be sent from the communication device 150 to position profile module 204 at the host device 120 for further processing.

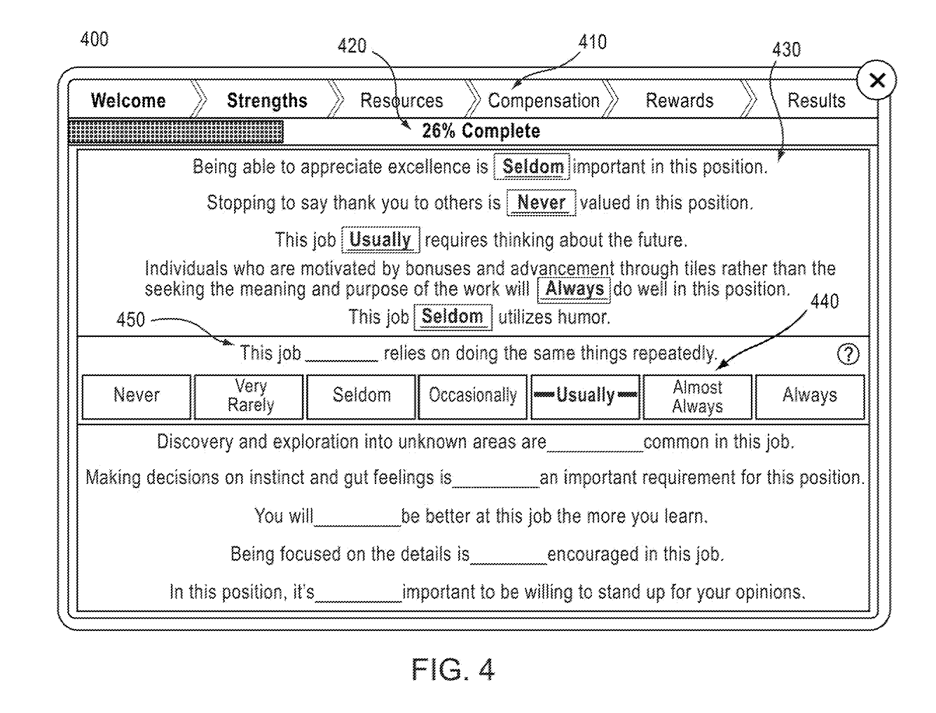

For example, a role assessment interface can be provided to an evaluator to evaluate a candidate's psychological fit for a job opening. FIG. 4 is an illustration of a role assessment interface 400 configured to be provided to an evaluator, according to an embodiment. The role assessment interface 400 for the role assessment is designed to maximize engagement and minimize completion time for the evaluator. As shown in FIG. 4, a progress meter 410 (including “welcome”, “strengths”, “resources”, “compensation”, “rewards” and “results”) is shown at the top of the role assessment interface 400, to provide an indication of a current step to the evaluator or any other participant. A percentage value 420 is also shown under the progress meter 410 to indicate a percentage of the role assessment that has been completed (e.g., “26% complete” as shown in FIG. 4).

The role assessment interface 400 includes a role assessment 430 that can be presented to the evaluator. In some embodiments, the role assessment 430 can be presented as sentence completion tasks along with multiple response options for each sentence to be completed. For example, as shown in FIG. 4, the role assessment 430 can take the form of sentence completion using a frequency scale range including “never”, “very rarely”, “seldom”, “occasionally”, “usually”, “almost always”, and “always”. Formally, this is a normative survey using a seven point Likert scale and consisting of a combination of positively keyed, negatively keyed, and omitted queries. Alternatively, the role assessment 430 can be presented in other forms, such as a questionnaire including a set of questions along with a set of potential answers to each question.

For the role assessment 430 presented in the role assessment interface 400, the evaluator can complete each of the sentences using one of the provided options. For example, the evaluator can complete a sentence such as “[t]his job usually relies on doing the same things repeatedly.” For another example, the evaluator can complete another sentence such as “[t]his job seldom utilizes humor.” Additionally, in some embodiments, the evaluator can optionally skip an item (e.g., a question), leaving it unanswered.

Furthermore, to help facilitate fast and seamless usage, the role assessment interface 400 can present the response options 440 in-line with the active sentence 450 in a highlighted row. In some embodiments, once answered, the completed sentence automatically scrolls up and the next sentence slides into place in the highlighted row. This carousel effect minimizes scrolling and allows the evaluator to stay focused on responding to the queries. Further, since the responses are in-line, cursor movement (e.g., using a computer mouse) is also minimized. For example, at a first time, a first sentence “[t]his job_relies on doing the same things repeatedly” (i.e., sentence 450) is highlighted as a current query, together with a set of possible answers to the first sentence (e.g., “never”, “very rarely”, “seldom”, “occasionally”, “usually”, “almost always”, “always” in the response options 440). Similarly, at a second time, a second sentence “[d]iscovery and exploration into unknown areas are_common in this job” is highlighted as the current query, together with a set of possible answers to the second sentence (not shown in FIG. 4).

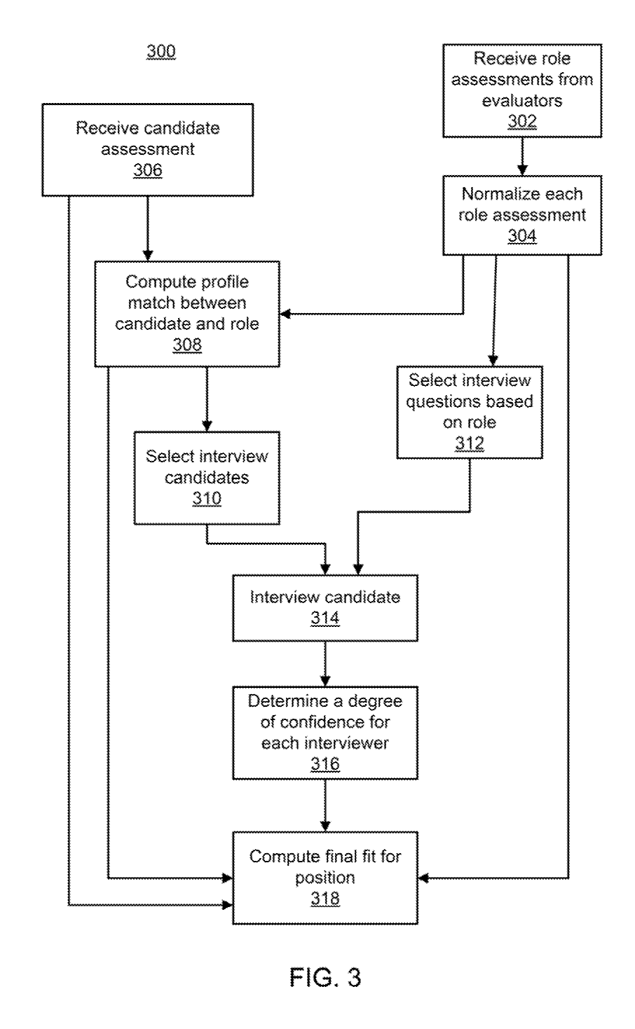

Returning to FIG. 2, after an evaluator has completed the full set of role assessment queries, the role assessment can be scored. In some embodiments, the role assessment can be scored using the seven point Likert scale. Specifically, each positively keyed item (e.g., question) for a facet increases that facet's score, and each negatively keyed item (e.g., question) for the facet decreases that facet's score. In some embodiments, omitted items for a facet can be tracked for research purposes but not contribute to the final score of that facet. Subsequently, scores for the facets from an evaluator taking the role assessment can be normalized based on the previous response distribution of that evaluator. Details of normalizing scores for the role assessment are described herein with respect to FIG. 3.

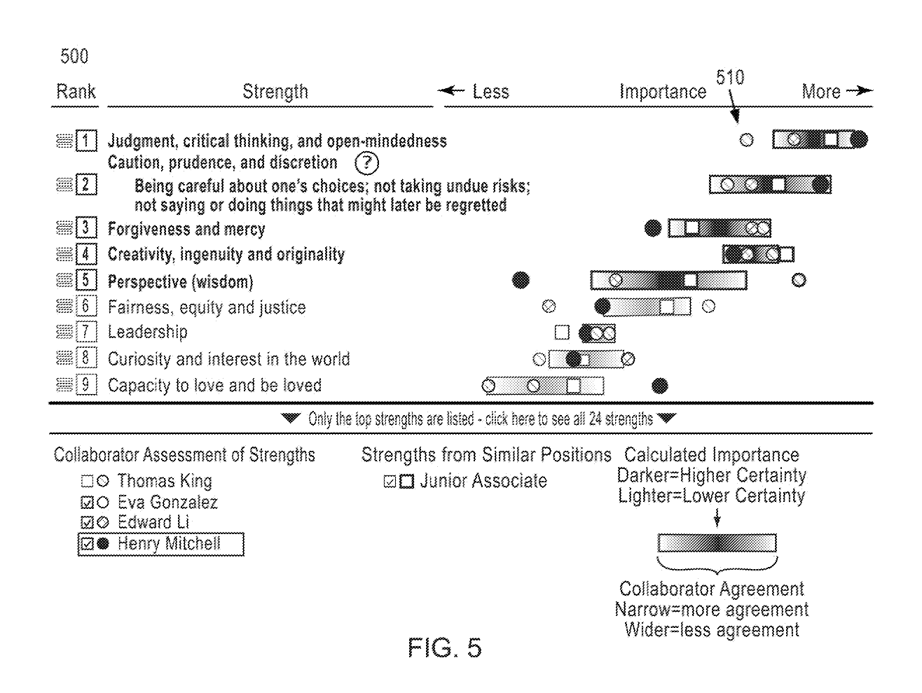

After the selected evaluators have completed the role assessment, a user (e.g., a hiring manager) can visualize the relative importance of facets for the role. FIG. 5 is an illustration of a position profile review interface 500, according to an embodiment. As shown in FIG. 5, the position profile review interface 500 presents a table illustrating a set of top facets (e.g., strengths) that are generally associated with success as a junior associate. Specifically, each row in the table corresponds to a specific facet associated with the role. A gradient bar in each row simultaneously captures a level of importance of the facet to the role and an indication of a level of agreement of each evaluator for a level of importance of each facet.

The gradient bar for each facet can be produced based on a probability distribution of the role assessment scores for that facet that are provided from the evaluators. For example, the center point of the gradient bar shows the mean (represented by mᵢ for facet i) of the normalized scores for the facet from the evaluators; and the agreement among the evaluators is shown as the width of the gradient bar, which is equal to two times the standard deviation (represented by sᵢ for facet i) of the normalized scores for that facet from the evaluators. Additionally, in some embodiments, a pop-up legend with additional detail information for a facet (not shown in FIG. 5) can be provided when a user places a cursor (e.g., using a mouse) over one of the gradient bars.

In some embodiments, the position profile review interface 500 can present data for individual evaluators as well as data from any similar positions selected for use in the role assessment process. Each dot (e.g., dot 510 shown in FIG. 5) in a row in the table represents a normalized score for a facet associated with the role from an evaluator. Data from individual evaluators can be selectively excluded if desired. For example, as shown in FIG. 5, data from the evaluator Thomas King is excluded from the presentation, while data from the evaluators Eva Gonzalez, Edward Li and Henry Mitchell is included in the presentation. Also, for those facets where there is disagreement (e.g., wide gradient bar), the position profile review interface 500 can serve to facilitate discussion to uncover the source of the disagreement among the evaluators.

After a consensus has been reached among the evaluators, the hiring manager can reorder the facets so as to select, for example, the five facets that will be of top priority in the position profile. In some embodiments, the order of the facets can be automatically determined based on the mean of the normalized scores for each facet. For example, as shown in FIG. 5, the first three facets in the top three rows (i.e., “judgment, critical thinking, and open-mindedness”, “caution, prudence, and discretion” and “forgiveness and mercy”) are in an order of a decreased mean of normalized scores. In some other embodiments, the order of the facets can be manually arranged by the hiring manager based on a combined consideration on the mean and the standard deviation of the normalized scores for each facet, and/or any other factors. For example, the facets in the third row and the fourth row (i.e., “forgiveness and mercy” and “creativity, ingenuity, and originality”) can have their order switched by the hiring manager.

In some embodiments, when one or more facets have their positions manually modified in the ranking of facets in a position profile, the relative importance (i.e., mean of the normalized scores) and certainty (i.e., standard deviation of the normalized scores) of the facets with modified positions can be re-determined. In some embodiments, for example, a “flag pole” algorithm can be used to determine the new scores for facets with modified positions, where the facets that were not modified are used as reference points (or “flags in the ground”), from which scores for the facets with modified positions can be anchored. Specifically, in some embodiments, if the facet at the first position is modified, the facet currently at the first position can be assigned the score for the facet previously at the first position. Similarly, in some embodiments, if the facet at the last position (e.g., the 24^{th} position) is modified, the facet currently at the last position can be assigned the score for the facet previously at the last position. In some embodiments, unmodified facets keep their scores and act as reference points. For modified facets other than the first position or the last position, their means can be set to be evenly distributed between nearest enclosing reference points, and their standard deviations can be set to, for example, half the distance between the nearest enclosing reference points.

In the example of FIG. 5, the facet in the third row (i.e., “forgiveness and mercy”) and the facet in the fourth row (i.e., “creativity, ingenuity, and originality”) can have their order switched by the hiring manager. As a result of applying the “flag pole” algorithm, the means for the facets currently in the third row and the fourth row are now evenly distributed between the nearest enclosing reference points, which are the means for the facets in the second and the fifth rows. Meanwhile, the standard deviations for the facets currently in the third and the fourth rows can be modified accordingly.

Alternatively, the new scores for facets with modified positions can be determined by any other suitable means. For example, the new scores can be arbitrarily determined by the hiring manager that modifies the positions of the facets, dependent on or independent of the scores of other modified or unmodified facets. Ultimately, after the order of the facets is manually arranged, a consensus on the top facets for a role can be established, thus the position profile for the role can be finalized.

Returning to FIG. 2, after a candidate profile containing normalized scores on facets for a candidate is available at candidate profile module 202, and a set of position profiles containing normalized scores on facets for a role from a group of evaluators is available at position profile module 204, a mutual psychological fit with the role can be initially calculated for the candidate at pre-interview analysis module 206. As a result, a candidate can be ranked relative to each of the other candidates based on their psychological fit for the role, and one or more candidates can be selected for an interview based on the resulted ranking.

Pre-interview analysis module 206 can be configured to conduct such an initial fit screening. In some embodiments, pre-interview analysis module 206 can be configured to use a Mahalanobis distance to compute a profile match between a candidate's self assessment (i.e., candidate profile) and a role assessment (i.e., position profile), which represents an initial evaluation of the candidate's psychological fit for the role.

For example, the 24 abovementioned facets associated with a candidate or a role can be ranked based on the normalized role assessment scores for those facets, and placed into 4 groups based on the ranking: the first group consisting of the top 5 facets; the second group consisting of the 6^{th} to the 13^{th} facets; the third group consisting of the 14^{th} to the 19^{th} facets; the fourth group consisting the bottom 5 facets. Next, a Mahalanobis distance between {mᵢ, sᵢ} and uᵢ for each of the 4 groups can be calculated, where mᵢ represents the mean of the normalized role assessment scores on facet i, sᵢ represents the standard deviation of the normalized role assessment scores on facet i, and uᵢ represents the normalized candidate assessment score on facet i for a candidate. Then an inner product between the 4 calculated Mahalanobis distances (for the 4 groups) and a vector N=<n₀, n₁, n₂, n₃> is computed, where n₀˜n₃ represent the priorities assigned to the 4 groups, respectively. The values of n₀, n₁, n₂ and n₃ can be tuned by an operator of pre-interview analysis module 206, such as the hiring manager. The calculated inner product is thus a profile match score representing the psychological fit of the candidate for the role.

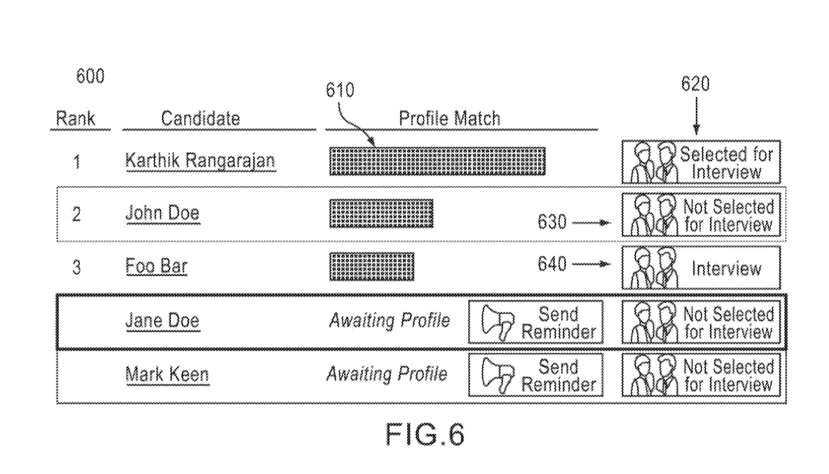

Based on the calculated profile match score of each candidate for the role, a visualized presentation of the profile match scores for the candidates can be generated by pre-interview analysis module 206. FIG. 6 is an illustration of a profile match ranking interface 600, according to an embodiment. As shown in FIG. 6, the profile match score for each candidate can be presented as a bar (e.g., bar 610 for the candidate Karthik Rangarajan in FIG. 6) associated with the candidate's name in a row in the profile match ranking interface 600. The candidates can be ranked in an order of a decreased profile match score. For example, the candidate Karthik Rangarajan has the highest profile match score; the candidate John Doe has the second highest profile match score; the candidate Foo Bar has the third highest profile match score; and the candidates Joane Doe and Mark Keen do not yet have a profile match score.

In some embodiments, each candidate's full profile can be viewed on the profile match ranking interface 600 in addition to his or her profile match ranking. In such embodiments, for example, placing a cursor (e.g., using a mouse) over a candidate's name can reveal a snapshot view (not shown in FIG. 6) of the candidate's full profile; and clicking on the name can navigate to the candidate's full profile page.

As an outcome of pre-interview analysis module 206, the profile match ranking interface 600 can provide a visualized tool for a manager (e.g., a hiring manager) to select candidates for an interview. In some embodiments, the manager can select a candidate for an interview based purely on the calculated profile match score and the corresponding ranking of that candidate. For example, as indicated by button 620 in FIG. 6, the candidate Karthik Rangarajan is selected for interview because he has the highest profile match score. In some other embodiments, the manager can depend on other factors in addition to the profile match scores and the ranking to make the decision. For example, as indicated by button 630 and 640 in FIG. 6, the candidate Foo Bar is considered to be selected for interview while the candidate John Doe is not selected for interview, even though the candidate John Doe has a higher profile match score than the candidate Foo Bar.

Returning to FIG. 2, after one or more candidates are selected for interviews, the manager can select a group of interviewers that will be participating in the interview. In some embodiments, each interviewer from the group of interviewers can receive an interview guide containing a set of interview questions to ask the candidates. Question compilation module 208 can be configured to generate the set of interview questions. The set of interview questions can be generated by question compilation module 208 based on the position profile previously defined for the role, such that each interview question included in the set of interview questions is tailored for the desired psychological facets associated with the role. In other words, the interview questions can be tied to the facets being sought after in the role's position profile.

In some embodiments, the interview questions can be designed to explore how a candidate has been able to apply the desired facets, as well as how he or she would ideally envision applying these facets in the role. The desired facets can be, for example, the top 5 facets (e.g., strengths) that have the highest normalized role assessment scores in the position profile of the role. In some embodiments, the interview questions can be selected from a database of a large number of interview questions, which can be stored in a memory accessible to question compilation module 208. For example, question compilation module 208 can be configured to generate the interview guide using 5 questions from the database, where each of the 5 questions is tied to each of the 5 top facets identified in the position profile of the role. In other embodiments, any number of questions can be generated.

Following each interview with a candidate, each interviewer can complete a set of follow-up assessment items (e.g., questions) as a post-interview assessment for that candidate. In some embodiments, the follow-up assessment items can be presented to the interviewer on a page of the interview guide following the interview questions, so that the interviewer may record his or her observations on the candidate following the interview. The set of follow-up assessment items can be generated by post-interview assessment module 210. In some embodiments, similar to question compilation module 208, post-interview assessment module 210 can be configured to select the follow-up assessment items from a database of a large number of follow-up assessment items, based on the position profile of the role.

In some embodiments, interviewers can be asked to assess two aspects in the follow-up assessment items after an interview with a candidate. First, the interviewers can assess their certainty that a given facet from the position profile of the role is one of the candidate's strengths in the candidate profile for that candidate. Responses from the interviewers on this aspect can be referred to as certainty responses. For example, a first type of a follow-up assessment item can take the form: “I_the candidate feels the most satisfied when bringing the strength under consideration to a challenge,” and request a six point Likert scale response tied to six levels of certainty response including “completely disagree”, “strongly disagree”, “disagree”, “agree”, “strongly agree”, and “completely agree.” In addition, the interviewer can indicate that they were unable to ascertain enough information to make a response.

Second, the interviewers can assess their certainty that the candidate expresses that facet at a level that is a good match for the role. Responses from the interviewers on this aspect can be referred to as transform responses. For example, a second type of a follow-up assessment item can take the form: “compared to the ideal candidate, the candidate's level of strength in question is_,” and request a five point Likert scale response tied to five levels of transform response including “far too little”, “too little”, “about right”, “too much”, and “far too much.” Again, the interviewer can indicate that they were unable to ascertain enough information to make a response. In other embodiments, interviewers can assess any number of aspects. In other embodiments, the follow-up assessment items can be in any suitable form.

Similar to candidate profile module 202 configured to receive a candidate profile from a candidate, and position profile module 204 configured to receive a position profile (i.e., role assessment) from an evaluator, post-interview assessment module 210 can be configured to receive a post-interview assessment from each interviewer. In some embodiments, an interviewer can access a communication device, which is remotely coupled to a host device hosting post-interview assessment module 210, to complete the post-interview assessment. In such embodiments, the post-interview assessment completed by the interviewer can be sent from that communication device to post-interview assessment module 210 at the host device. In the example of FIG. 1, an interviewer can access the communication device 160 to complete a post-interview assessment, which is presented to the interviewer on display 166. Alternatively, the interviewer can complete a post-interview assessment included in the interview guide, and then enter the completed post-interview assessment into the communication device 160. Subsequently, the post-interview assessment completed by the interviewer can be sent, via the network 170, from the communication device 160 to post-interview assessment module 210 hosted at host device 120. In some other embodiments, an interviewer can directly access a host device that hosts post-interviewer assessment module 210 to complete the post-interview assessment.

After follow-up responses on a candidate are received from the interviewers at post-interview assessment module 210, post-interview analysis module 212 can be configured to make a detailed assessment and analysis of fit for that candidate. Post-interview analysis module 212 is configured to compute a mapping between the normalized role assessment scores corresponding to the position profile and the normalized scores corresponding to the candidate profile (i.e., candidate's self-assessment). The responses to the follow-up assessment items obtained from the interviewers can be utilized to compute this mapping. As discussed above, the responses regarding certainty that a given facet from the position profile is one of the candidate's strengths in the candidate profile, which can be referred to as certainty responses, can be used to establish confidence intervals around the candidate's self-assessed ratings. This can provide a check against a pure candidate's self-assessment, and allow the hiring manager to favor those candidates where the interviewers have more certainty regarding their strengths. Moreover, the responses regarding the interviewers' assessments that the candidate expresses the facets at a level that is a good match for the role, which can be referred to as transform responses, can be used to calculate a mapping between the uncorrelated role assessment and candidate's self-assessment.

As an example, the following algorithm can be used to compute the mapping that provides the best fit between the normalized role assessment scores and the normalized candidate assessment scores by minimizing error. Alternatively, any other suitable algorithm that can quantitatively measure the fit between a position profile of a role (i.e., role assessment results) and a candidate profile of a candidate (i.e., candidate assessment results) can also be used. In the mathematical formulations presented herein, mᵢ represents the mean of the normalized role assessment scores (from the evaluators) for facet i; sᵢ represents the standard deviation of the normalized role assessment scores (from the evaluators) for facet i; and u represents the normalized candidate assessment score for facet i.

First, for a number of top facets (e.g., for each of the top 5 facets) identified in the position profile, if an interviewer's transform response (i.e., the interviewer's assessment that the candidate expresses the facets at a level that is a good match for the role) is not uncertain, a transformed point tᵢ is selected for facet i. For example, based on the five point Likert scale response tied to the five levels of transform responses described herein, if the transform response is “far too little”, tᵢ is selected as max(0, mᵢ−5sᵢ); if the transform response is “too little”, tᵢ is selected as [mᵢ−max(0, mᵢ−5sᵢ)]/2; if the transform response is “about right”, tᵢ is selected as mᵢ; if the transform response is “too much”, tᵢ is selected as [mᵢ+min(1, mᵢ+5sᵢ)]/2; if the transform response is “far too much”, tᵢ is selected as min(1, mᵢ+5sᵢ). The numerical parameters illustrated here can be tuned based on the specific scenarios.

Second, a coefficient cᵢ for facet i can be computed such that tᵢ=cᵢuᵢ. The coefficients {cᵢ} (for the facets) are the coefficients per facet per interviewer that linearly map between the means of the normalized candidate assessment scores and the transformed points based on the interviewer's transform response. After these coefficients are calculated, the uncertainty that the interviewers had about the candidate's facets can be used in the analysis as shown below.

Third, for a number of top facets (e.g., each of the top 5 facets) identified in the position profile, if the interviewer's certainty response (i.e., the response regarding certainty that a given facet from the position profile is one of the candidate's top facets) is not uncertain, a certainty point oᵢ can be selected for facet i. In some embodiments, for example, based on the six point Likert scale response tied to the six levels of certainty response described herein, if the certainty response is “completely disagree”, oᵢ is selected as |uᵢ| (i.e., square root of uᵢ̂2); if the certainty response is “strongly disagree”, oᵢ is selected as |uᵢ−0.2|; if the certainty response is “disagree”, oᵢ is selected as |uᵢ−0.4|; if the certainty response is “agree”, oᵢ is selected as |uᵢ−0.6|; if the certainty response is “strongly agree”, oᵢ is selected as |uᵢ−0.8|; if the certainty response is “completely agree”, oᵢ is selected as |uᵢ−1|. In some embodiments, a candidate's normalized score for facet i (i.e., uᵢ) is normalized between 0 and 1. In such embodiments, if the interviewer's certainty that facet i, identified by a candidate assessment as a top facet, is a top facet for the candidate (i.e., the interviewer “completely agrees” that the facet is a top facet), then the normalized score for facet i (uᵢ) will be near 1 and the resulting selected variance (oᵢ) will be small (e.g., near zero). In such embodiments, if the candidate assessment does not identify the facet as a strength but the interviewer believes the facet to be a strength (i.e., the interviewer “completely agrees” that the facet is a top facet), the resulting variance will be large (e.g., near one). For another example, if the interviewer's certainty that facet i, identified by a candidate assessment as a top facet, is not a top facet for the candidate (i.e., the interviewer “completely disagrees” that the facet is a top facet), then the normalized score for facet i (uᵢ) will be near 1 and the resulting selected variance (oᵢ) will be large (e.g., near one). For yet another example, if the candidate assessment does not identify the facet as a strength and the interviewer believes that the facet is not a strength (i.e., the interviewer “completely disagrees” that the facet is a top facet), the resulting variance will be small (e.g., near zero). In some embodiments, the numerical parameters illustrated herein can be tuned based on the specific scenarios. Thus, the assigned variance (oᵢ) can reflect an interviewer's certainty with respect to the candidate's self assessed score. In other embodiments, any other method can be used to assess an interviewer's certainty of the facets identified in a candidate assessment.

Fourth, a coefficient k that falls within the range of calculated mapping coefficients and minimizes the overall error can be computed. Similarly stated, the coefficient k can be used to find the mapping most consistent with the interviewer feedback under the assumption of mutual-inconsistencies. For example, the coefficient k can be computed such that k falls into [min(cᵢ), max(cᵢ)] and the error function E is minimized using linear regression, where E=sum[(kuᵢ−cᵢuᵢ)/zᵢ]̂2 is a summation over the corresponding facets, and zᵢ=square root of [sᵢ̂2+(cᵢoᵢ)̂2] represents the propagated error for facet i.

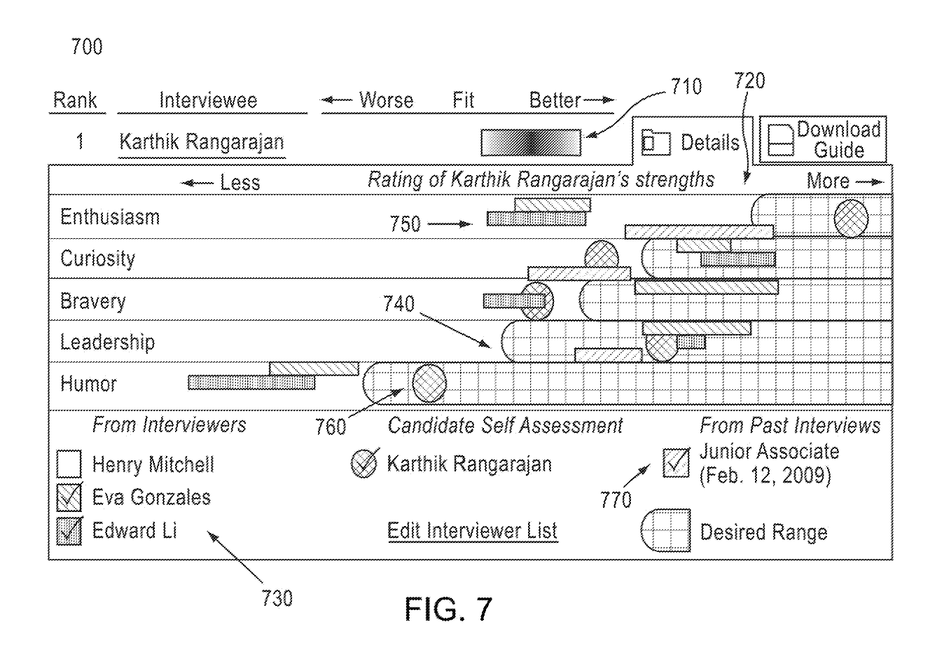

Fifth, a transformed mean pᵢ and a transformed standard deviation qᵢ for facet i can be computed as: pᵢ=kuᵢ, and qᵢ=square root of [sum(cᵢ−pᵢ)̂2/v], where v represents the number of cᵢ (which is within [1, 5]) and the summation is over the corresponding facets. In some embodiments, the calculated transformed results can be presented in a details section of a visualization interface for the candidate, which includes a detailed breakdown of fit by facet for that candidate. Details of the visualization interface are described with respect to FIG. 7.

Sixth, an overall fit indicator can be calculated for the candidate. In some embodiments, a Bhattacharyya distance, a metric that measures the similarity of two probability distributions, can be utilized to calculate the overall fit indicator. Thus, the top facets (e.g., top 5 facets) and bottom facets (e.g., bottom 5 facets) from the position profile of the candidate can be weighted differently.

In some embodiments, the overall fit indicator can be calculated as follows. For each interviewer, the Bhattacharyya distance between {pᵢ, qᵢ} and {mᵢ, sᵢ} for, for example, 4 groups (e.g., top 5 facets, the 6^{th} to the 13^{th} facets, the 14^{th} to the 19^{th} facets, bottom 5 facets) can be calculated. Next, the inner product of the calculated Bhattacharyya distances with the vector R=<r₀, r₁, r₂, r₃ can be calculated, where r₀˜r₃ represent the priorities assigned to the 4 groups, respectively. Similar to the vector N discussed with respect to pre-interview analysis module 206, the values of r₀, r₁, r₂ and r₃ can be tuned by an operator of post-interview analysis module 212, such as the hiring manager. In some embodiments, the vector N and the vector R can be identical. In other embodiments, the vector N and the vector R can be different. Ultimately, the resulting inner product, which is represented by F₁, can be a single point fitness measure for interviewer I.

Seventh, an overall fit indicator that factors in the selected interviewers' opinions can be determined by computing the mean and standard deviation of the single point fitness measure from each selected interviewer. Similarly stated, the mean m and standard deviation s across all F₁ for the corresponding interviewers can be computed. Such an overall fit indicator can indicate a degree of match between a candidate and the role. As described herein, this ultimate overall fit indicator can be computed based on the candidate profile (candidate's self-assessment), the set of position profiles (role assessments), and the set of post-interview assessments.

At this point, enough information has been obtained to generate a visualization interface for the candidate, which includes both the overall fit indicator and the detailed breakdown of fit by facet for that candidate. FIG. 7 is an illustration of a post-interview analysis interface 700, according to an embodiment. The post-interview analysis interface 700 contains an overall evaluation of fit as well as a breakdown of fit by facet for the candidate Karthik Rangarajan. As shown in FIG. 7, the overall fit indicator for the candidate Karthik Rangarajan is shown as a gradient bar 710 at the top of the post-interview analysis interface 700, where the gradient bar 710 is generated based on the mean (m) and the standard deviation (s) of the single point fitness measure from each interviewer (e.g., F₁ for interviewer I). Specifically, the gradient bar 710 is centered at m and its width is twice of s.

A details section 720 of the post-interview analysis interface 700 is presented under the overall fit indictor (represented by the gradient bar 710) for the candidate Karthik Rangarajan. A number of checkbox style controls 730 are at the bottom of the details section, which allow a user (e.g., the hiring manager) to selectively show a subset of the data. For example, an interviewer's response can be excluded by unchecking their name at the bottom of the post-interview analysis interface 700. As a result, the values presented in the post-interview analysis interface 700 (including the overall fit indicator represented by the gradient bar 710 and the results shown in the details section 720) can be recalculated to exclude the data from those unchecked interviewers. In the example of FIG. 7, the checkbox for the interviewer Henry Mitchell is not selected, which indicates that the results presented in the post-interview analysis interface 700 do not include the data provided by the interviewer Henry Mitchell.

As shown in FIG. 7, the background of the details section contains a set of lanes, one per facet, and within each lane is a hash mark filled area 740 referred to in the legend as the “Desired Range.” The leftmost point of this range 740 is the ideal target fit for a facet as determined by the position profile. An ideal candidate would have the ratings (e.g., by an interviewer or by the candidate's self-assessment) for each of their facets aligned at the leftmost point for each range 740. If the rating falls to the left of this point (thus falling outside the desired range 740), then the candidate's relative level of that facet is somewhat less than ideal, such as the ratings from the interviewers Eva Gonzales and Edward Li on the facet “enthusiasm” for the candidate Karthik Rangarajan, shown as the gradient bars 750. On the other hand, if the rating falls to the right of this point, then the candidate's relative level of that facet is somewhat more than ideal, such as the self-assessment rating from the candidate Kartik Rangarajan on the facet “leadership”, shown as the circle 760. In some embodiments, a candidate possessing a more than ideal relative level of a given facet is preferable to a less than ideal relative level of that facet.

Additionally, in some embodiments, if the candidate has interviewed with the company for a role in the past, a gradient bar combining the means and uncertainties for each of the previous interviewers for that facet can be shown in the post-interview analysis interface 700. For example, as indicated by the legend 770 in FIG. 7, gradient bars representing the results from a previous interview of the candidate Karthik Rangarajan for a junior associate position on Feb. 12, 2009 are shown in the details section 720 of the post-interview analysis interface 700.

Similar to the post-interview analysis interface 700 generated for the candidate Karthik Rangarajan, a post-interview analysis interface can be generated for each remaining candidate. Furthermore, the candidates can be ranked, based on their post-interview analysis interfaces, according to their psychological fit for the role. In some embodiments, for example, the candidates can be ranked based on a decreased order of their means (m) for the overall fit indicators.

In the example of evaluating candidates' psychological fit for a job opening, after the hiring manager has evaluated a sufficient number of candidates against the role requirements and for psychological fit, a hiring decision can be made. In some embodiments, one or more candidates can be selected for the role based on their calculated overall fit indicators. For example, a candidate with the highest overall fit indicator can be hired for the role (e.g., the particular position). As described herein, the detailed assessment of fit for each candidate and the corresponding visualization interfaces allow the hiring manager to quickly compare and contrast candidates, manage the workflow to obtain feedback from interviewers, and assess the impact of individual interviewers on the ranking of the candidates. While discussed in the context of hiring an individual for a job opening, the methods and apparatus described herein can also be used to, for example, assess strengths and/or weaknesses in organizations, evaluate candidates for a promotion, determine staffing on a particular project, etc.

Communication module 214 can be operatively coupled to each of the remaining modules included in the processor 200, and configured to facilitate communication between the processor 200 of a host device (e.g., the host device 120 of FIG. 1) and one or more communication devices (e.g., communication devices 150, 160 in FIG. 1). Accordingly, the other modules of the processor 200 can use communication module 214 to send data to and receive data from the communication devices. For example, candidate profile module 202 can use communication module 214 to receive data associated with a candidate profile from a communication device. For another example, position profile module 204 can use communication module 214 to send data associated with a questionnaire of a role assessment to a communication device.

FIG. 3 is a flowchart illustrating a method for evaluating a candidate's psychological fit for a role, according to an embodiment. In the example of hiring an individual for a job opening, after a particular and/or specific role (i.e., the job opening) is identified, a manager (e.g., hiring manager) can invite other co-workers to perform as evaluators to help assess facets for the role by completing a role assessment. Meanwhile, the manager can obtain a candidate assessment from each potential candidate for the role.

At 302, role assessments can be received from evaluators. In some embodiments, if the role is similar to one or more previously evaluated roles, the manager for the role can elect to include the position profiles (i.e., role assessments) for those roles as a starting point to generate an initial position profile for the current role. Next, each selected evaluator can complete a role assessment of the role. In some embodiments, the role assessment can be in the form of a questionnaire including questions about facets desired for the role. In some embodiments, such a role assessment can be completed by each evaluator using a role assessment interface such as the role assessment interface 400 shown and described with respect to FIG. 4. Furthermore, the role assessment interface can be presented to the evaluator on a display of a communication device (e.g., the display 156 in the communication device 150 in FIG. 1) from, for example, a position profile module (e.g., position profile module 204 in FIG. 2) in a host device (e.g., the host device 120 in FIG. 1). Subsequently, the completed role assessment can be sent from the communication device to the position profile module at the host device. Additionally, after the completed role assessment is received at, for example, the position profile module, the role assessment can be scored. In some embodiments, a Likert scale method can be used to calculate a numeric score for each facet associated with the role based on the completed role assessment from each evaluator, as described in detail with respect to FIG. 2.

At 304, each role assessment can be normalized. Specifically, the numeric score for each facet associated with the role based on the completed assessment from each evaluator can be normalized at, for example, the position profile module (e.g., position profile module 204 in FIG. 2). In some embodiments, the scores for the facets associated with the role can be normalized based on the previous response distribution of the evaluators taking the role assessment. For example, if a first evaluator is taking her first ever role assessment, the distribution of the numerical scores (e.g., as per the Likert scale) of her responses can be recorded, and then that distribution can be used to normalize the scores for each facet to the range [0, 1]. Thus, the lowest scored facet can be assigned a numeric value of 0, and the highest can be assigned a numeric value of 1. For another example, if a second evaluator has previously taken several role assessments, the full history of his responses and the resulting distribution can be utilized during the normalization step. Because of this, it is possible for a normalized score to be less than 0 or higher than 1.

Such a normalization step can correct individual bias in the interpretation of the words used as answers in the role assessment. For example, if the first evaluator normally constrains her answers so that they fall between “seldom” and “almost always”, and the second evaluator normally uses the full range between “never” and “always”, their original scores may not be comparable to each other, while their normalized scores can be comparable to each other. As a result, a score on each facet associated with the role is obtained from each evaluator, and normalized. Subsequently, as described in detail with respect to position profile module 204 in FIG. 2, the normalized scores on each facet associated with the role from the evaluators can be reviewed by the manager, and a position profile for that role can be finalized. In some embodiments, a position profile of a role can be visualized and presented using a position profile review interface, such as the position profile review interface 500 shown and described with respect to FIG. 5.

At 306, a candidate assessment can be received from each candidate. As described with respect to FIG. 2, a candidate assessment can be provided to each candidate by, for example, a candidate profile module (e.g., candidate profile module 202 in FIG. 2). The candidate assessment can be standard across various roles or specialized for each different role. In some embodiments, similar to the role assessment for the role, the candidate assessment can be in the form of a questionnaire including items (e.g., questions) querying the self-assessment from the candidate on each facet.

In some embodiments, similar to the role assessment for the role, the candidate assessment can be presented to the candidate on a display of a communication device (e.g., the display 156 in the communication device 150 in FIG. 1) from, for example, a candidate profile module (e.g., candidate profile module 202 in FIG. 2) in a host device (e.g., the host device 120 in FIG. 1). Subsequently, the completed candidate assessment can be sent from the communication device to the candidate profile module at the host device. Alternatively, a specific web address that links to a webpage containing the candidate assessment can be provided to the candidate, and the candidate can complete the candidate assessment using any computer device (e.g., desktop computer, laptop, etc.) that can access the webpage. The completed candidate assessment can be received at, for example, a candidate profile module at a host device that hosts the webpage.

As a result, a candidate assessment can be received from a candidate, and a relative role that one or more facets play in the candidate's life can be determined based on the received candidate assessment for that candidate. In some embodiments, as described with respect to candidate profile module 202 in FIG. 2, a score on each facet can be calculated for a candidate based on the received candidate profile for that candidate, and the score can be further normalized based on a probability distribution of the candidate's answers to the queries associated with the facets in the candidate assessment.

At 308, a profile match can be computed between the candidate and the role. Specifically, the mutual fit between the candidate and the role can be calculated based on the received candidate assessment (i.e., candidate profile), which represents the candidate's self-assessment, and the received role assessments (i.e., position profiles), which represents the evaluators' assessments of the role. The resulting profile match presents an initial evaluation of the candidate's psychological fit for the role. In some embodiments, such a calculation can be conducted at, for example, a pre-interview analysis module (e.g., pre-interview analysis module 206 in FIG. 2). In some embodiments, a Mahalanobis distance can be used to calculate the profile match. Details of calculating a Mahalanobis distance are described with respect to pre-interview analysis module 206 in FIG. 2.

In some embodiments, based on the calculated profile match for each candidate with the role, a visualized presentation of the profile match for the candidates (e.g., the profile match ranking interface 600 shown and described with respect to FIG. 6) can be generated by the pre-interview analysis module (e.g., pre-interview analysis module 206 in FIG. 2). Furthermore, candidates can be ranked based on the profile match scores determined for them, as shown in the profile match ranking interface 600 in FIG. 6.

At 310, interview candidates can be selected. In some embodiments, candidates can be selected for an interview by the manager based on the profile match ranking of the candidates. For example, as shown in FIG. 6, the candidate Karthik Rangarajan that has the highest profile match score is selected for an interview. In some other embodiments, the manager can consider other factors in addition to the profile match score and the ranking, such as the candidate profile and the position profile, to select interview candidates.

At 312, interview questions can be selected based on the role. In some embodiments, interview questions can be selected by, for example, a question compilation module (e.g., question compilation module 208 shown and described with respect to FIG. 2) based on the position profile for the role. The interview questions can be selected such as to allow the interviewer to listen and observe multiple responses from the interviewees. For example, the interview questions can be designed to be open-ended so that they permit multiple facets to be demonstrated in the response they solicit, and so as to not bias or lead the candidate into believing a “correct” response in-line with a particular facet is desired. In some embodiments, along with the interview questions, a set of follow-up assessment items (e.g., questions) can also be provided to each selected interviewer. The follow-up assessment items can be used by the interviewers to perform a post-interview assessment for the candidate, as described with respect to post-interview assessment module 210 in FIG. 2.

At 314, candidates can be interviewed. Specifically, the candidates selected at 310 can be interviewed by a group of interviewers, who are selected by the manager. Following the interview, each interviewer can complete a set of follow-up assessment items as a post-interview assessment for that candidate. The follow-up assessment items can be generated by, for example, a post-interview assessment module (e.g., post-interview assessment module 210 in FIG. 2). In some embodiments, the interview questions and/or the follow-up assessment items can be selected from a database that contains a large number of interview questions and/or follow-up assessment items.

At 316, a degree of confidence for each interviewer can be determined. As discussed with respect to post-interview analysis module 212 in FIG. 2, the response to the follow-up assessment items obtained from each interviewer can be used to determine the degree of confidence for the interviewer around the candidate's self-assessment. Specifically, the responses regarding certainty that a given facet from the position profile is one of the candidate's top facets in the candidate profile (i.e., the interviewer's certainty response) can be used to establish confidence intervals around the candidate's self-assessed ratings. Such a degree of confidence can be determined using a method previously described with respect to post-interview analysis module 212 in FIG. 2.

At 318, a final fit for the role can be computed. Specifically, an overall fit indicator can be computed based on the degree of confidence determined at 316, the profile match computed at 308, the normalized role assessment scores obtained at 304, and the normalized candidate assessment scores obtained at 306. In some embodiments, a Bhattacharyya distance can be used in calculating the overall fit indicator. Details of calculating the overall fit indicator are described with respect to post-interview analysis module 212 in FIG. 2. As a result, a post-interview analysis interface (e.g., post-interview analysis interface 700) can be generated for each candidate, which includes both the overall fit indicator and the detailed breakdown of fit by facet for that candidate. Furthermore, the candidates can be ranked based on, for example, their overall fit indicators. Thus, a candidate with the highest overall fit indicator can be selected by the manager for the role.

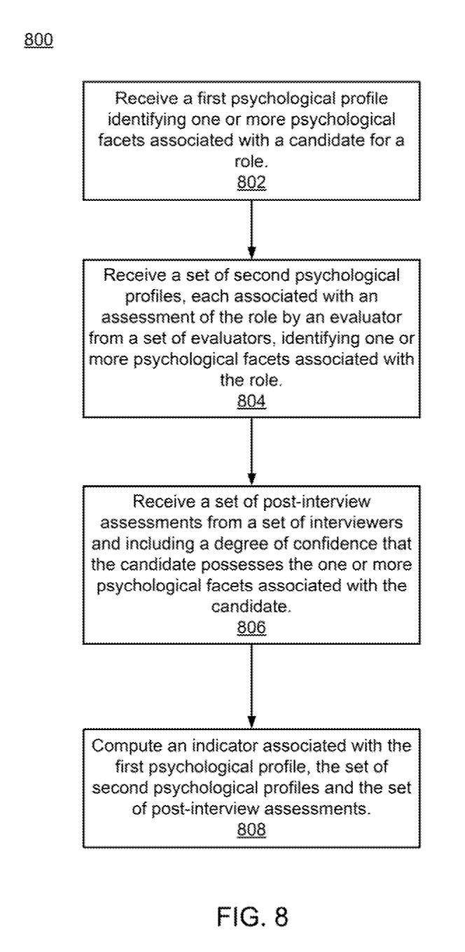

FIG. 8 is a flowchart illustrating a method for computing an indicator associated with a candidate's psychological fit for a role, according to an embodiment. At 802, a first psychological profile can be received, where the first psychological profile identifies one or more psychological facets associated with a candidate for a role. The first psychological profile can be received from a candidate as a result of the candidate completing a candidate assessment associated with the role. The candidate assessment can be in the form of a questionnaire including assessment items (e.g., questions) that query the candidate about one or more psychological facets. In some embodiments, the responses provided by the candidate can be used to generate the first psychological profile, which can then be sent to, for example, a candidate profile module. As described herein, such a first psychological profile can be referred to as a candidate profile.

In the example of FIG. 2, candidate profile module 202 of processor 200 at a host device (e.g., host device 120 in FIG. 1) can be configured to provide a candidate assessment to a candidate that accesses a communication device (e.g., the communication device 160 in FIG. 1). The candidate assessment is designed to identify one or more psychological facets associated with the candidate for a role. After the candidate completes the candidate assessment, a candidate profile for that candidate is generated based on that candidate's answers and sent to the host device. As a result, the candidate profile is received at candidate profile module 202.

At 804, a set of second psychological profiles can be received, where each second psychological profile from the set of second psychological profiles is associated with an assessment of the role by an evaluator from a set of evaluators, and the set of second psychological profiles identifies one or more psychological facets associated with the role. Similar to the candidate profile, each second psychological profile can be received from an evaluator as a result of the evaluator completing a role assessment associated with the role. The role assessment can be in the form of a questionnaire including assessment items (e.g., questions) that query the evaluator about the psychological facets desired for the role. The responses provided by the evaluator can be used to generate the second psychological profile, which can then be sent to, for example, a position profile module. As described herein, such a second psychological profile can be referred to as a position profile.

In the example of FIG. 2, position profile module 204 of processor 200 at a host device (e.g., host device 120 in FIG. 1) can be configured to provide a role assessment to an evaluator that accesses a communication device (e.g., the communication device 16Q in FIG. 1). The role assessment is designed to identify one or more psychological facets associated with the role. After the evaluator completes the role assessment, a position profile from that evaluator associated with the role is generated based on the evaluator's answers and sent to the host device. As a result, the position profile is received at position profile module 204.

At 806, a set of post-interview assessments can be received from a set of interviewers, where the set of post-interview assessments includes a degree of confidence that the candidate possesses the one or more psychological facets associated with the candidate. Each of the post-interview assessments can be received from an interviewer after the interviewer completes a set of follow-up assessment items (e.g., questions) following an interview with a candidate. The set of follow-up assessment items can include questions that query the interviewer about the performance of the candidate in the interview, including the degree of confidence that the candidate possesses the one or more psychological facets associated with the candidate. The responses to the follow-up assessment items can be used to generate the post-interview assessment for that interviewer, which can then be sent to, for example, a post-interview assessment module for further processing.

In the example of FIG. 2, post-interview assessment module 210 of processor 200 at a host device (e.g., host device 120 in FIG. 1) can be configured to provide a set of follow-up assessment items to an interviewer that accesses a communication device (e.g., the communication device 160 in FIG. 1). The follow-up assessment items are designed to determine a degree of confidence that a candidate possesses the one or more psychological facets associated with the candidate. After the interviewer completes the follow-up assessment items following an interview with the candidate, the responses from the interviewer to the follow-up assessment items are used to generate a post-interview assessment for that interviewer, which is then sent to the host device. As a result, the post-interview assessment is received at post-interview assessment module 210.

At 808, an indicator can be computed, which is associated with the first psychological profile, the set of second psychological profiles, and the set of post-interview assessments. Specifically, an indicator that indicates the overall fit of the candidate for the role can be computed based on the candidate profile for the candidate, the set of position profiles associated with the role from the evaluators, and the set of post-interview assessments from the interviewers. In some embodiments, the overall fit indicator can be computed at, for example, a post-interview analysis module. Furthermore, the overall fit indicator can be used to rank the candidate against other candidates, thus to help the manager to make a decision (e.g., a hiring decision).

In the example of FIG. 2, after the candidate profile is received at candidate profile module 202, the set of position profiles is received at position profile module 204, and the set of post-interview assessments is received at post-interview assessment module 210, post-interview analysis module 212 can be configured to compute an overall fit indicator of the candidate for the role based on the received candidate profile, position profiles and post-interview assessments. As a result, the computed overall fit indicator can be used to rank the candidate against other candidates, and be used in making a hiring decision. While discussed above with respect to FIG. 8 as about hiring an individual for a job opening, the methods and apparatus described herein can also be used for other purposes, such as evaluating strengths and/or weakness of an organization, evaluating a fit of an individual for a particular task, evaluating candidates for a promotion, and/or the like.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to be executed by a processor, the code comprising code to cause the processor to:
receive a first psychological profile identifying one or more psychological facets associated with a candidate for a role;
receive a plurality of second psychological profiles identifying one or more psychological facets associated with the role, each second psychological profile from the plurality of second psychological profiles being associated with an assessment of the role by an evaluator from a plurality of evaluators;
receive a plurality of post-interview assessments, each assessment from the plurality of post-interview assessments being from an interviewer from a plurality of interviewers and including a degree of confidence that the candidate possesses the one or more psychological facets associated with the candidate; and
compute an indicator associated with the first psychological profile, the plurality of second psychological profiles and the plurality of post-interview assessments.

2. The non-transitory processor-readable medium of claim 1, the code further comprising code to cause the processor to:
compute a first probability distribution based on the plurality of second psychological profiles; and
compute a second probability distribution based on the first psychological profile and the plurality of post-interview assessments,
the code to cause the processor to compute the indicator including code to cause the processor to compute the indicator based on the first probability distribution and the second probability distribution.

3. The non-transitory processor-readable medium of claim 1, wherein the code to cause the processor to compute includes code to cause the processor to compute the indicator using a Bhattacharyya distance.

4. The non-transitory processor-readable medium of claim 1, wherein the first psychological profile is based on a normative Likert survey associated with the candidate.

5. The non-transitory processor-readable medium of claim 1, the code further comprising code to cause the processor to:
normalize each second psychological profile from the plurality of second psychological profiles associated with the role based on a history of responses associated with the evaluator from the plurality of evaluators associated with that second psychological profile from the plurality of second psychological profiles.

6. The non-transitory processor-readable medium of claim 1, wherein the indicator indicates a degree of match between the candidate and the role.

7. The non-transitory processor-readable medium of claim 1, further comprising code to cause the processor to:
provide an assessment interface to each evaluator from the plurality of evaluators, the assessment interface configured to present a plurality of assessment items to each evaluator from the plurality of evaluators along with a plurality of possible responses to each assessment item from the plurality of assessment items,
a first assessment item from the plurality of assessment items being a current item at a first time, a second assessment item from the plurality of assessment items being the current item at a second time, the plurality of possible answers being presented adjacent to the first assessment item at the first time and adjacent to the second assessment item at the second time.

8. The non-transitory processor-readable medium of claim 1, further comprising code to cause the processor to:
provide an assessment interface to an evaluator from the plurality of evaluators;
present, during a first time period, a first assessment item from a plurality of assessment items as a current item to the evaluator;
receive a response to the first assessment item from the evaluator; and
scroll, in response to the response to the first assessment item, such that a second assessment item from the plurality of assessment items is presented as the current item to the evaluator during a second time period after the first time period.

9. An apparatus, comprising:
a candidate profile module configured to generate a psychological profile associated with a candidate for a role based on an assessment of the candidate, the candidate profile module configured to identify one or more psychological facets of the candidate based on the psychological profile associated with the candidate;
a position profile module configured to receive a plurality of psychological profiles associated with the role, each psychological profile from the plurality of psychological profiles being associated with an assessment of the role by an evaluator from a plurality of evaluators, the position profile module configured to identify one or more psychological facets associated with the role based on the plurality of psychological profiles;
an analysis module configured to compute an indicator associated with a comparison of the one or more psychological facets of the candidate and the one or more psychological facets associated with the role, the indicator configured to be used to select the candidate for an interview; and
a question compilation module configured to select a set of interview questions from a plurality of interview questions that elicit information usable to assess whether the candidate possesses the one or more psychological facets associated with the role.

10. The apparatus of claim 9, further comprising:
a post-interview assessment module configured to select a set of post-interview assessment items from a plurality of post-interview assessment items that elicit information usable to assess an interviewer's degree of confidence that the candidate possesses the one or more psychological facets of the candidate.

11. The apparatus of claim 9, wherein the analysis module is configured to compute the indicator using a Mahalanobis distance associated with the one or more psychological facets of the candidate and the one or more psychological facets associated with the role.

12. The apparatus of claim 9, wherein the position profile module is configured to modify an order of importance of the one or more psychological facets associated with the role based on a user input.

13. The apparatus of claim 9, wherein the position profile module is configured to calculate an importance score for each psychological facet from the one or more psychological facets based on the plurality of psychological profiles associated with the role.

14. The apparatus of claim 9, wherein the psychological profile associated with the candidate for the role is based on a normative Likert survey associated with the candidate.

15. A non-transitory processor-readable medium storing code representing instructions to be executed by a processor, the code comprising code to cause the processor to:
receive a psychological profile associated with a candidate for a role;
receive a plurality of psychological profiles associated with the role, each psychological profile from the plurality of psychological profiles being associated with an assessment of the role by an evaluator from a plurality of evaluators;
normalize each psychological profile from the plurality of psychological profiles associated with the role based on a history of responses associated with an evaluator from the plurality of evaluators associated with that psychological profile from the plurality of psychological profiles to produce a plurality of normalized psychological profiles; and
compute an indicator associated with a comparison of the psychological profile associated with the candidate and the plurality of normalized psychological profiles, the indicator configured to provide an indication of a psychological fit between the candidate and the role.

16. The non-transitory processor-readable medium of claim 15, wherein the code to cause the processor to compute includes code to cause the processor to compute the indicator using a Mahalanobis distance associated with the psychological profile associated with the candidate and the plurality of normalized psychological profiles.

17. The non-transitory processor-readable medium of claim 15, wherein the psychological profile associated with the candidate identifies one or more psychological facets of the candidate.

18. The non-transitory processor-readable medium of claim 15, wherein the plurality of psychological profiles identifies one or more psychological facets associated with the role.

19. The non-transitory processor-readable medium of claim 15, wherein the psychological profile associated with the candidate for the role is based on a normative Likert survey associated with the candidate.

20. The non-transitory processor-readable medium of claim 15, wherein the plurality of psychological profiles identifies a plurality of psychological facets associated with the role, the code further comprising code to cause the processor to:
modify an order of importance of the plurality of psychological facets associated with the role based on a user input.

21. The non-transitory processor-readable medium of claim 15, wherein the psychological profile associated with the candidate identifies a plurality of psychological facets of the candidate, the code further comprising code to cause the processor to:
select a set of post-interview assessment items from a plurality of post-interview assessment items that elicit information usable to assess an interviewer's degree of confidence that the candidate possesses the plurality of psychological facets of the candidate.

22. The non-transitory processor-readable medium of claim 15, wherein the plurality of psychological profiles identifies a plurality of psychological facets associated with the role, the code further comprising code to cause the processor to:
select a set of interview questions from a plurality of interview questions that elicit information usable to assess whether the candidate possesses the plurality of psychological facets associated with the role.
